(19) United States
(12) Patent Application Publication
(10) Pub. No.: US 2015/0136567 A1
(43) Pub. Date: May 21, 2015

(54) Internal Screw Unit

(71) Applicant: Quan Siang Technology Development Co., Ltd., Kaohsiung City (TW)

(72) Inventor: Jung-Ping Sun, Kaohsiung City (TW)

(73) Assignee: Quan Siang Technology Development Co., Ltd., Kaohsiung City (TW)

(21) Appl. No.: 14/080,808

(22) Filed: Nov. 15, 2013

(51) Int. Cl. B65G 33/20

(52) U.S. Cl. CPC B65G 33/20
USPC 198/662; 198/657

(57) ABSTRACT

An internal screw unit includes a screw-included tube assembly and a power source that supplies power. The screw-included tube assembly includes a tubular body in which a screw is arranged. The screw has an outer circumferential edge that is fixedly connected to an inside surface of the tubular body in a seamless manner so that when the power source drives the tubular body or the screw to rotate, the tubular body and the screw are rotated in unison with each other. Through feeding realized with the rotation of the screw in the tubular body, applications in conveyance of fluids (such as water and oil), solids (such as corn kernels, grains, and plastic particles) can be available. Additional applications are also available for fields of screw stirring and fluid power generation. Numerous advantages can be achieved, including complete enclosure, improved structural strength, steady flow speed, and extended life span.

### (a) TECHNICAL FIELD OF THE INVENTION

The present invention generally relates to internal screw unit, and more particularly to a technical field where a screw blade is fixedly connected to an inside surface of a hollow tubular body in a seamless manner.

### (b) DESCRIPTION OF THE PRIOR ART

In the mechanical engineering field, conveyance devices available for conveying fluids (such as water and oil), solids (such as corn kernels, grains, and plastic particles) or gases are quite numerous, among which the commonly known ones include a belt conveyor for conveying solid objects, a centrifugal pumps for conveying liquids or mixtures of liquids and gases, a conveying device for conveying mixtures of liquids and gases or solid objects. Taking an internal screw conveyance device as an example, as shown in FIG. 1, such a device generally comprises a screw-included tube assembly “a” and a power source “b”. The screw-included tube assembly “a” comprises a hollow tubular body 10 having an inside circumferential surface to which an inner rubber lining 20 is mounted with a screw 30 axially received therein. The power source “b” generally functions to drive the screw 30 to rotate, whereby through feeding induced by the rotation of the screw 30 in the tubular body 10, conveyance of fluids (such as water and oil) or solids (such as corn kernels, grains, and plastic particles) can be realized.

However, such a known internal screw conveyance suffers the following disadvantages:

(1) During an operation, the tubular body 10 is kept stationary and the screw 30 is put into rotation, so that even there is an inner rubber lining 20 mounted to the inside circumferential surface of the tubular body 10, the enclosure is not complete during the conveyance of a fluid (the conveyed object) so that leaks may result and flow speed and flow rate cannot be kept steady.

(2) During an operation, since the tubular body 10 and the screw 30 are not rotated in unison with each other, solids (the conveyed object), when conveyed, may get jamming between the tubular body 10 and the screw 30, wherein in the worst cases, the power source “b” may get damaged.

(3) After an operation of conveying solids, a jamming object, if not removed, may lead to corrosion and get moldy, leading to contamination to other conveyed objects in the subsequent operations of conveyance. Further, The inner rubber lining 20 is put in abrading contact with the screw 30, generally in a long period of time, and may get chemically deteriorated and release chemical substances that might contaminate the conveyed objects. Further, the long-term abrasion and stress concentration may lead to breaking of the screw 30.

(4) The parts of the inner rubber lining 20 must be additionally provided, which increases the number of parts, and may leads to increased risk of malfunctioning and inconvenience of maintenance.

(5) In a case that the tubular body 10 is made up of several sections jointed to each other, drawbacks of for example power strength of connection and deteriorated tightness of engagement may result.

(6) In cases where the screw 30 must possess both features of a single blade and multiple blades, due to the fact that the tubular body 1 and the screw 30 are not rotated in unison with each other, the multiple blades that bear a relatively greater pressure may get broken and separated. For such a reason, the conventionally used screw 30 is not made in the form including both a single-blade section and a multiple-blade section.

### SUMMARY OF THE INVENTION

In view of such problems, the present invention aims to provide a device that ensures complete enclosure, improved structural strength, steady flow speed, and extended life span.

For such purposes, the present invention adopts a technical structure that is an internal screw unit, which generally comprises a screw-included tube assembly, to which a power source is coupled. The screw-included tube assembly comprises a hollow tubular body and a screw. The tubular body has an inside surface. The screw has an outer circumferential forming an outer circumferential edge. The power source drives the screw to rotate. The improvement is that the outer circumferential edge of the screw is fixedly connected to the inside surface of the tubular body in a seamless manner so that when the power source drives the screw to rotate, the tubular body is caused to rotate in unison therewith. As such, the drawbacks of the prior art can be improved and the expected purposes can be achieved.

The tubular body is made up of a plurality of tubular sections jointed to each other. The screw is made up of a plurality of screw sections jointed to each other. The screw has a solid screw shaft, or the screw comprises a central bore, or the screw has a tubular screw shaft.

The screw comprises a single screw blade, or the screw comprises a single-blade section and a multiple-blade section, wherein the single blade section comprises a single helical blade and the multiple-blade section comprises at least two parallel helical blades. Further, the power source may be of an operation mode where the power source drives the tubular body to rotate so that the screw can also be driven to rotate in unison therewith.

Thus, the primary object of the present invention is to make an outer circumferential edge of a screw to fixedly connect to an inside surface of a hollow tubular body in a seamless manner so that when being driven by a power source, the screw and the tubular body are rotated in unison with each other to thereby achieve the desired purposes of improving tightness of engagement, improving coupling strength, being hard to get malfunctioning, being hard to damage the power source, and being free of contamination.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing the structure of a conventional internal screw conveyance device.

FIG. 2 is a cross-sectional view showing the structure of an embodiment of the present invention.

FIG. 3 is a perspective view showing a screw-included tube assembly according to the present invention, wherein a screw comprises a solid screw shaft.

FIG. 4 is a cross-sectional view showing a screw-included tube assembly according to the present invention, wherein a screw comprises a single-blade screw section and a multiple-blade screw section.

FIG. 5 is a cross-sectional view showing a structure of a screw-included tube assembly according to the present invention, wherein the screw comprises a solid screw shaft.

FIG. 5A is a transverse cross-sectional view of FIG. 5.

FIG. 6 is a cross-sectional view showing another structure of a screw-included tube assembly according to the present invention, wherein the screw comprises a central bore.

FIG. 6A is a transverse cross-sectional view of FIG. 6.

FIG. 7 is a cross-sectional view showing a further structure of a screw-included tube assembly according to the present invention, wherein the screw comprises a tubular screw shaft.

FIG. 7A is a transverse cross-sectional view of FIG. 7.

FIGS. 8-10 shows embodiments of a power source according to the present invention.

FIG. 11 is a cross-sectional view showing another embodiment of the present invention.

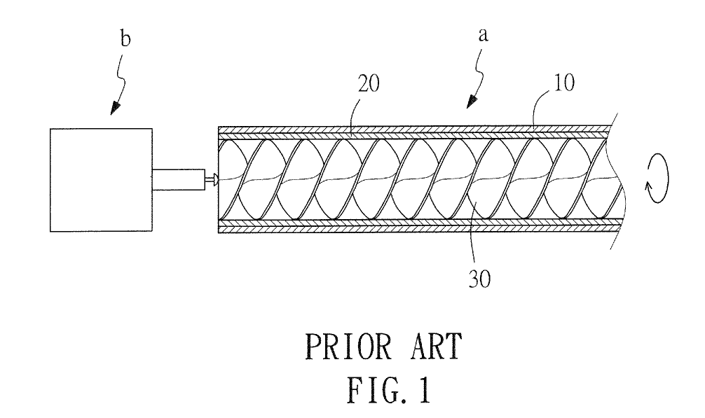

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

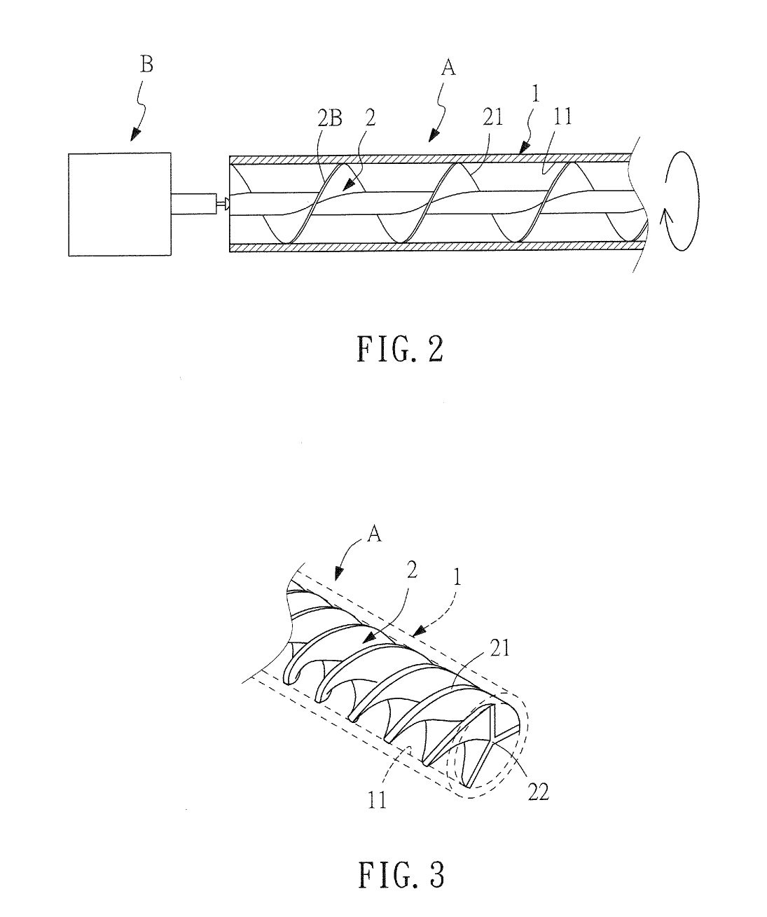

As shown in FIG. 2, the present invention provides an internal screw unit, which generally comprises a screw-included tube assembly A and a power source B is additionally provided for supply of power.

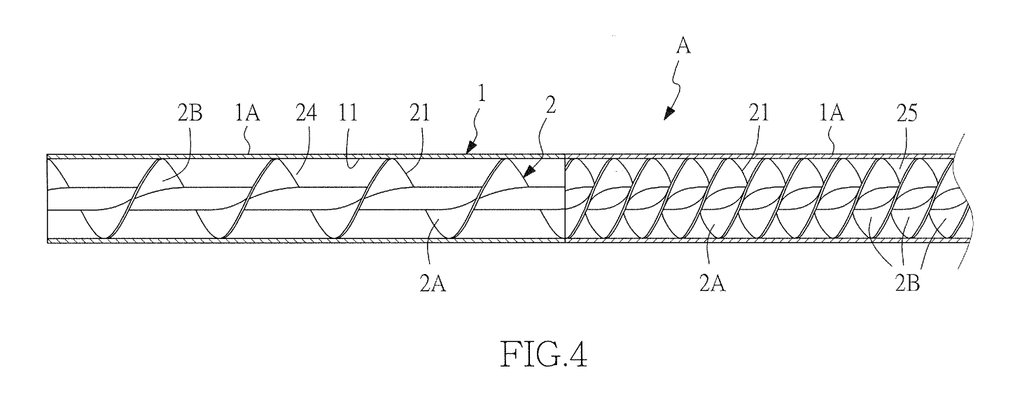

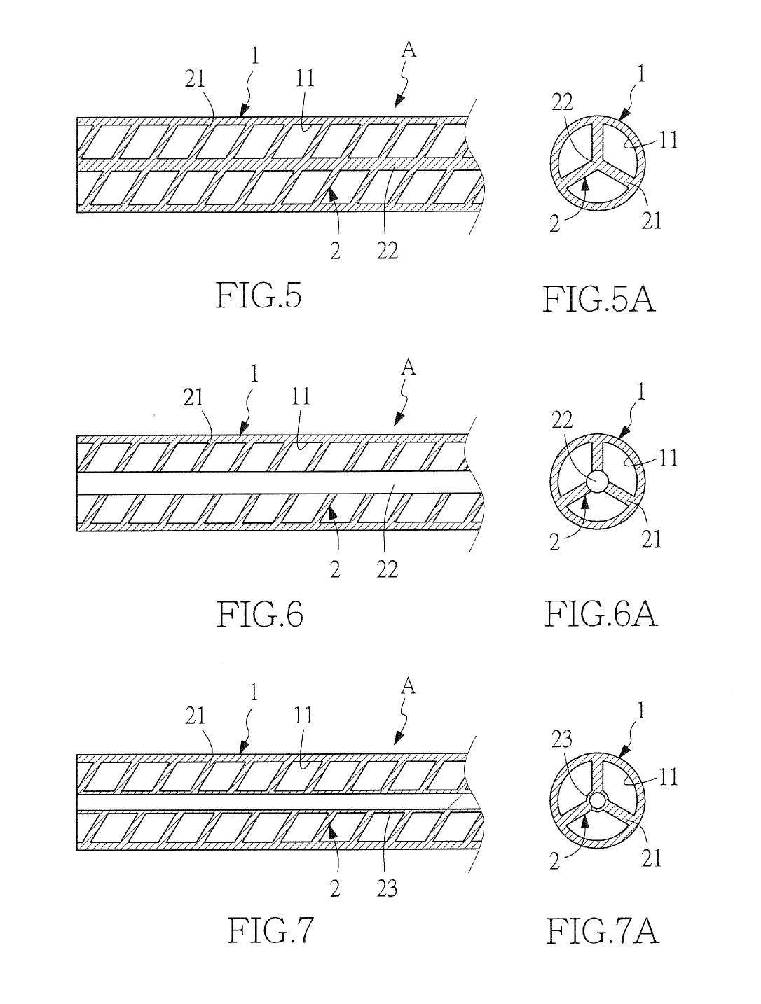

The screw-included tube assembly A comprises a hollow tubular body 1 and a screw 2 (FIGS. 2 and 3). The hollow tubular body 1 has an inside surface 11. The tubular body 1 can be made up of a plurality of tubular sections 1A jointed to each other (as shown in FIG. 4). The screw 2 can be formed of a plurality of screw sections 2A jointed to each other. The screw 2 has an outer circumferential edge 21 and the outer circumferential edge 21 is formed so as to be in seamless engagement and fixedly connected to the inside surface 11 of the tubular body 1 (also see FIGS. 5-7 and 5A-7A), whereby the tubular body 1 and the screw 2 are rotatable in unison with each other when one of them is rotated.

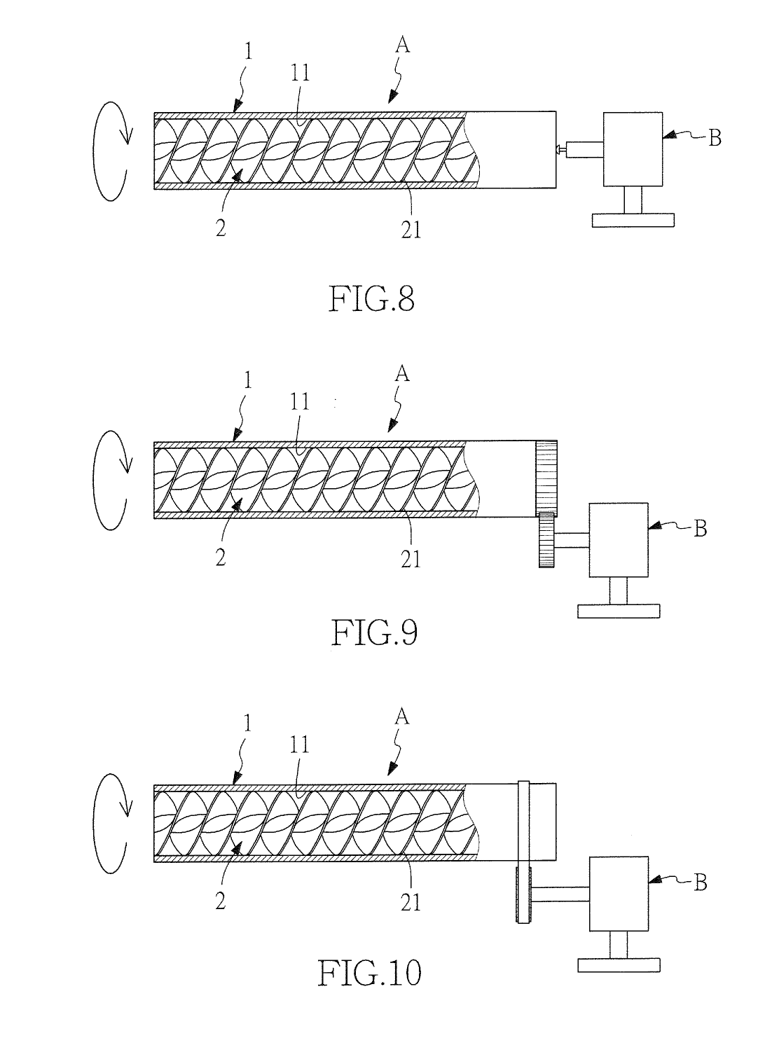

The power source B is arranged to directly drive the screw 2 to rotate (see FIGS. 2 and 8) or is alternatively arranged to directly drive the tubular body 1 to rotate (FIGS. 9 and 10). The power source B can be a motor, armature means based on magnetic expulsion, or other power device (such as hydraulic or wind power). An arrangement that can be used to drive the tubular body 1 to rotate includes gear transmission (see FIG. 9) or belt transmission (see FIG. 10).

Further, the screw 2 may selectively comprise a solid screw shaft 22 (see FIGS. 5 and 5A), which is fit for applications requiring upward conveyance. Alternatively, the screw 2 can be of a hollow screw shaft 22 (see FIGS. 6 and 6A). In other words, the screw shaft 22 itself is a central bore defining a central axis of rotation. Or, alternatively, the screw 2 has a tubular screw shaft 23 (see FIGS. 7 and 7A), wherein the screw shaft 23 has a hollow internal space. The hollow screw shaft 22 or the tubular screw shaft 23 is fit for applications of horizontal conveyance.

Further, the screw 2 can be a structure made up of a single helical blade 2B (see FIG. 2), or alternatively, the screw 2 can be made up of a screw section 24 having a single screw blade and a screw section 25 having multiple screw blades 25 (see FIG. 4). The single-blade section 24 comprises a single screw blade 2B, while the multiple-blade section 25 comprises at least two parallel and helically-extending screw blades 2B (three screw blades being exemplified in FIG. 4, similar examples of three screw blades being illustrated in FIGS. 5-7).

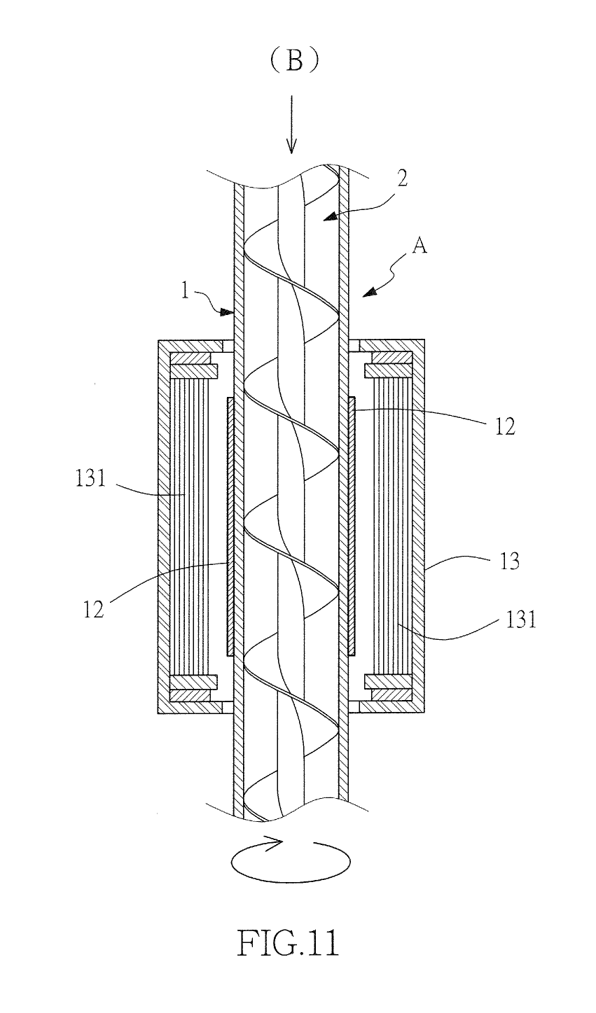

Further, the screw-included tube assembly A is applicable to conveyance of fluids (such as water, oil, liquid metal, liquid chemical substances, and the likes) or solids (such as corn kernels, grains, sands/gravels, feeds, tea leaves, plastic particles, and the likes), or can be alternatively used as an internal screw-stirring means for blenders and meat grinder, or, as shown in FIG. 11, can alternatively find applications in fluid (hydraulic) power generation, wherein a plurality of magnetic bodies 12 is attached to an outer circumferential surface of the tubular body 1 and an armature element 13 is provided outside the tubular body 1 and the armature element 13 comprises windings 131, whereby when a water flow (which serves as the power source B in this application) rushes downward into the tubular body 1, the screw 2 is caused to rotate and the tubular body 1 is forced to rotate synchronously so that the magnetic bodies 12 are caused to rotate to have the magnetic force lines cut through the armature element 13 and an electrical current is induced to supply electricity to an external load. In this way, hydraulic power generation facility is formed.

Further, the screw-included tube assembly A can be constructed in such a way that the screw 2 is only arranged in a section or a part of the interior of the tubular body 1.

With the above described arrangement and structure, when the present invention is put into practice, a power source B, which can be of any type, is applied to drive the screw 2 to rotate (FIG. 8) or to drive the tubular body 1 to rotate (FIGS. 9 and 10). Under both conditions, the tubular body 1 and the screw 2 are rotated in unison with each other. Further, since the outer circumferential edge 21 of the screw 2 is fixedly connected to the inside surface 11 of the tubular body 1 in a seamless manner, at least the following advantages can be achieved:

(1) In conveying a fluid, since the interior of the screw-included tube assembly A is completely enclosed, no leak will occur and the flow speed and flow rate can maintain steady.

(2) Since the tubular body 1 and the screw 2 are fixed together and are rotatable in unison with each other, no jamming will occur in conveying solids (the conveyed objects), so that the operation of the power source B can be kept normal and the life span can be extended.

(3) The conveyed objects will not be contaminated during the conveyance and breaking of the screw 2 caused by stress concentration is eliminated or alleviated.

(4) The number of separate parts is reduced so that the risk of malfunctioning is reduced and maintenance is easy.

(5) In case that the tubular body 1 is made up of a plurality of tubular sections 1A jointed to each other, since the tubular body 1 and the screw 2 are fixedly connected, the strength of connection is improved and the tightness of engagement is excellent.

(6) The screw 2 can be made in the form of a single-blade section 24 and/or a multiple-blade section 25, wherein the multiple-blade section 25 is capable of bearing a strong pressure without breaking and separation, thus expanding the applications thereof.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An internal screw unit, which comprises a screw-included tube assembly that is adapted to couple to a power source, the screw-included tube assembly comprising a hollow tubular body and a screw, the tubular body having an inside surface, the screw having an outer circumferential edge, the power source driving the screw-included tube assembly to rotate, characterized in that:
the outer circumferential edge of the screw is fixedly connected to the inside surface of the tubular body in a seamless manner so that when the power source drives the screw to rotate, the tubular body is caused to rotate synchronously.

2. The internal screw unit according to claim 1, wherein the tubular body comprises a plurality of tubular sections jointed to each other and the screw comprises a plurality of screw sections jointed to each other.

3. The internal screw unit according to claim 1, wherein the screw comprises a solid screw shaft.

4. The internal screw unit according to claim 1, wherein the screw comprises a central bore.

5. The internal screw unit according to claim 1, wherein the screw comprises tubular screw shaft.

6. The internal screw unit according to claim 3, wherein the screw comprises a single helical blade.

7. The internal screw unit according to claim 3, wherein the screw comprises a single-blade section and a multiple-blade section, the single-blade section comprising a single helical blade, the multiple-blade section comprising at least two parallel helical blades.

8. The internal screw unit according to claim 3, wherein the power source drives the tubular body to rotate.

9. The internal screw unit according to claim 4, wherein the screw comprises a single helical blade.

10. The internal screw unit according to claim 4, wherein the screw comprises a single-blade section and a multiple-blade section, the single-blade section comprising a single helical blade, the multiple-blade section comprising at least two parallel helical blades.

11. The internal screw unit according to claim 4, wherein the power source drives the tubular body to rotate.

12. The internal screw unit according to claim 5, wherein the screw comprises a single helical blade.

13. The internal screw unit according to claim 5, wherein the screw comprises a single-blade section and a multiple-blade section, the single-blade section comprising a single helical blade, the multiple-blade section comprising at least two parallel helical blades.

14. The internal screw unit according to claim 5, wherein the power source drives the tubular body to rotate.
